(19) United States
(12) Patent Application Publication
(10) Pub. No.: US 2007/0006238 A1
(43) Pub. Date: Jan. 4, 2007

(54) Managing application states in an interactive media environment

(75) Inventors: James C. Finger, Kirkland, WA (US); John Andre Yovin, Woodinville, WA (US); Khurshed Mazhar, Kirkland, WA (US); Olivier Colle, Redmond, WA (US); Arthur William James Freeman, Kirkland, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/352,662

(22) Filed: Feb. 13, 2006

Related U.S. Application Data
(60) Provisional application No. 60/695,944, filed on Jul. 1, 2005.

(51) Int. Cl. G06F 9/46; G06F 17/00

(52) U.S. Cl. 719/328; 715/500.1

(57) ABSTRACT

Applications are managed in an interactive media environment by the creation of a logical model for the lifetime of an application. The model is applicable to concurrently and/or consecutively running applications and governs the creation of applications, manipulation of applications by other applications, resource consumption, visibility of an application to a user, and application shutdown in the interactive media environment using the construct of application “state.” A set of Booleans flags is utilized and unique combinations of elements in the Boolean flag set define a plurality of application states

### STATEMENT OF RELATED APPLICATION

This application claims the benefit of provisional application no. 60/695,944, filed Jul. 1, 2005, which is incorporated by reference herein.

### TECHNICAL FIELD

The described arrangements, systems and methods relate generally to interactive media and more particularly to managing application states in an interactive media environment.

### BACKGROUND

Interactive media environments are typically resource constrained in terms of available processing power, memory and other resources that are available to applications running in the environment. One common example of interactive media is video encoded on DVD (digital versatile disc) where users can interact with graphical menus to navigate to specific video content or invoke special features that are authored into the DVD.

In more complex interactive media environments, despite the limited resources, multiple applications are envisioned as needing to be run simultaneously without causing conflicts which might result in media content such as video to freeze or be otherwise disrupted. In addition, all applications that are used to define a particular interactive experience must always appear to be available to a user. Resource constraints may also dictate that applications be broken up and run sequentially over some time interval. In such cases, the implementation of a graceful transition between consecutive applications is necessary to prevent resource conflicts.

### SUMMARY

Applications are managed in an interactive media environment by the creation of a logical model for the lifetime of an application. Applications in the interactive media environment are used to create and manipulate graphical objects in a synchronous manner with video object to create a rich interactive experience. The model is applicable to concurrently and/or consecutively running applications and governs the creation of applications, manipulation of applications by other applications, resource consumption, visibility of an application to a user, and application shutdown in the interactive media environment using the construct of application “state.”

A set of Booleans flags is utilized and unique combinations of elements in the Boolean flag set define a plurality of application states. Multiple applications typically run simultaneously and each moves from state to state and occupies transitional states during its runtime lifetime in the environment according to script (for example, ECMAScript standardized by Ecma International) and markup documents (for example, a World Wide Web Consortium (W3C) extensible markup language (XML) document file) which define the application, and interactions with the user.

Presentation behavior of content in the environment are controlled, and resources such as events, pictures, sounds, fonts in the interactive media environment are managed (e.g., allocated, used and consumed by applications) according to application state of each of the applications in the environment.

Application state management using the Boolean flag model is implemented, in an illustrative arrangement, using an interactive media player comprising an interactive content processor and a video content processor which mix the graphics and video in a real time on a synchronized basis. The interactive media player is realized in dedicated hardware in some settings, or alternatively using a software implementation employing computer readable media with a general purpose processor such as that found in a personal computer.

In an illustrative example, the Boolean flag set has elements which include: Valid, Selected, Ready, Loaded and Active. The Boolean flag set may also be extended to include the additional elements of Shutdown in Process, Loading and Error.

Advantageously, application state management provides a stable and predictable methodology for interactive media authors to implement multiple applications in a real-time setting where hardware resources including processor cycles and memory are limited. In addition, the logical application state management model provides interactive media authors with the ability to use a single application “library” that they can readily customize on a per disc basis, for example, to implement interactive graphical menus using different languages, but utilizing a common menu logic.

### BRIEF DESCRIPTION OF THE DRAWINGS

FIG. 1 is an illustrative block diagram showing the elements making up an application used in an interactive media environment;

FIG. 2 is an illustrative diagram which show the relationship among multiple markup documents and script;

FIG. 3 is a block diagram of a first illustrative interactive media player including an interactive content processor, a video content processor and a mixer;

FIG. 4 is a block diagram of a second illustrative interactive media player;

FIG. 5 shows a set of five elements used in first illustrative example of application state management employing Boolean flags;

FIG. 6 shows an extended set of eight elements used in a secondillustrative example of application state management employing Boolean flags;

FIG. 7 is a diagram of a state machine which illustrates transient and persistent application states; and

FIG. 8 is a flow chart showing an illustrative method for shutting d own an interactive media application.

### DETAILED DESCRIPTION

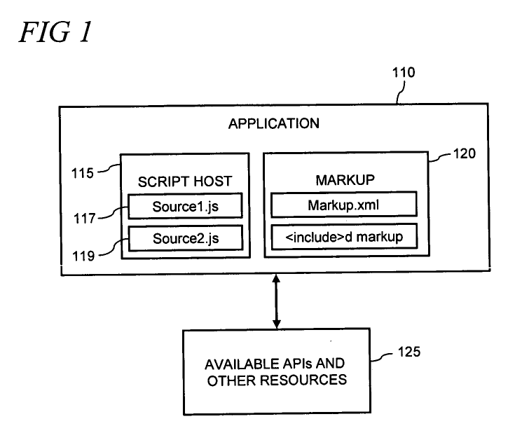

Referring to FIG. 1, an illustrative block diagram of the elements making up an application 110 used in an interactive media environment is shown. Applications are typically used in the interactive media environment to enable interaction between a user and an interactive media player rendering graphics and video on a coupled display device (such as a television or monitor) through a user interface such as a remote control. More specifically, applications control presentation behavior of various content objects, including video playback, in the environment. Presentation of graphic objects such as menus and interactive buttons over the video is also realized using applications. Applications further manage and control audio playback and sounds in the environment. It is contemplated that multiple applications will generally be running simultaneously in most interactive media settings. However, there is no requirement the multiple applications run simultaneously and the decision to divide or aggregate applications in a particular setting is a design choice of the interactive media author. Applications may also be logically subdivided into application pages depending on the requirements of a specific setting.

The application 110 comprises a script host 115 containing zero or more script files 117 and 119 and zero or more markup documents 120 that is used to generate a document object model (DOM). The markup documents 120 include information relating, for example, to content, style, timing and layout of graphic objects. Thus, the markup context is used generally to provide graphics on a graphics plane in the interactive media environment.

In this illustrative example, the markup documents are XML document files in accordance with W3C standards. As indicated in FIG. 1, multiple physical XML files may be accessed using the <include> element in the <head> section of the markup. In some settings it may be preferable for an application to not have more than one active markup at a time. However, an application may switch its markup 120 by using a <link> element in the markup. Alternatively, an application may switch its markup 120 by utilizing an application programming interface (API) that enables applications to gain access to functional objects within a current application. Using a loadMarkup ( ) call through the API, an application may switch markup files 120 by passing the Uniform Resource Identifier (URI) of the new markup through an API.

In cases where an application accesses a new markup, the API call takes effect only after a current event handler in the application finishes executing its current task. Any current markup-related event handlers that are pending are also cancelled as the new markup, once loaded, will invalidate those event handlers.

In this illustrative example, script host 115 contains script files 117 and 119 which are used along with the markup 120 to implement interactive media experiences. Script files 117 and 119 may be implemented, for example, using ECMAScript as defined by Ecma International in the ECMA-262 specification. Common scripting programming languages falling under ECMA-262 include JavaScript and JScript. In some settings, it may be desirable to implement scripts 117 and 119 using a subset of ECMAScript 262, in particular ECMA-327, along with a host environment and a set of common APIs. Script context in most settings is utilized to deal with interactive control issues from user along with system events, graphics control, video playback, resource management (e.g. use of caching or persistent store resources) and other issues that are not readily or efficiently implemented using solely markup 120.

The availability of APIs and resources to application 110 is indicated by reference numeral 125 in FIG. 1. Resources include, for example, audio and video files, fonts, pictures and images (e.g., in common file formats including PNG, JPEG, GIF, BMP, TIFF etc.) and other resources as may be required by an application according to the circumstances of a specific setting.

Each application 110 maintains its own script host 115 that maintains the context for the script's variables, functions and other states. In most settings, variables and functions in one application are not visible to another application unless the applications are specifically set up to enable such cross-application visibility, for example, by using an object that is shared across all applications. For example, in this illustrative example, the interactive media player object has a single instance that is shared across all applications. Optionally, therefore, special objects may be placed inside script host 115—for example, using a C++object—to implement singletons (i.e., a objects having limited instantiation) where the special objects all reference the same internal function, for example, of the player. This optional aspect enables interactive media script authors to logically treat common objects as singletons while still allowing the script host 115 to implement the functionality necessary to expose an object to the single script host.

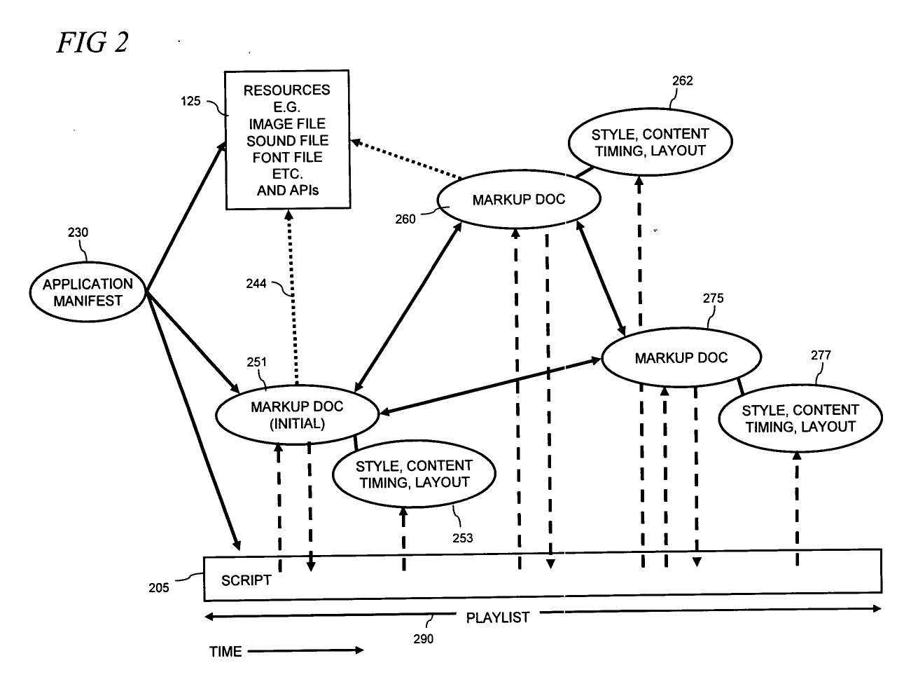

Referring now to FIG. 2, an illustrative diagram showing the relationship among multiple markup documents and script is provided. An application manifest 230 interacts with applications which, as noted above, are defined generally by resources 125, script 205, and markup documents 251, 260 and 275 as shown. Each application typically uses a single application manifest file in most settings, but the application manifest is not part of the runtime state of the application. In this illustrative example, the application manifest 230 is encoded as an XML document file.

The application manifest 230 describes the initial markup file 251 to be used by the application 110 (FIG. 1) as well as the script files—collectively indicated by the rectangle with reference numeral 205 in FIG. 2—contained in script host 115 (FIG. 1). If the application manifest 230 lists more than one script, as in this illustrative example, then all the scripts are loaded into a script handling engine in the interactive media player. Thus, the multiple script files are treated and behave as if the script author had concatenated all of the script files into a single large file in the order listed in the application manifest 230.

As shown in FIG. 2, the application manifest 230 refers to resources 125. The resources available to an application in an interactive media environment form a directed graph, rooted by the resources 125 referenced in the application manifest 230. The allowed extent of the graph for each application is proscribed by the application manifest 230.

FIG. 2 shows an application running in the interactive media environment. As noted above, an application may only have one active markup at a time and application content is kept separate by the applications. As indicated by the arrows between the markup pages 251, 260 and 275, via script 205, the application is able to advance from markup page 251 to 260, and then later from page 260 to 275.

The progression of context execution by applications in the interactive media environment is guided by a playlist 290 which describes, among other things, the relationship among objects in the environment including presentation objects that are rendered by the player onto the display device. These presentation objects typically include video (which may include multiple streams as described in more detail below) and graphics produced by the applications.

Playlist 290 further manages resources across the interactive media environment as a single management entity in order to efficiently allocate and control the consumption of resources by applications. As with the application manifest 230 the playlist 290 may be advantageously embodied as an XML document file in most settings.

The markup pages in FIG. 2 may be used in some settings to fire events into an execution context (created by the script files 117 and 119 in FIG. 1). The execution context then manipulates the DOM created by the current application markup. As the markup is used in the interactive media environment to specify style, content, timing and layout of graphical objects in the environment (as represented by elements 253 262 and 277 in FIG. 2), the combination of script and markup enables the creation of a comprehensive set of capabilities.

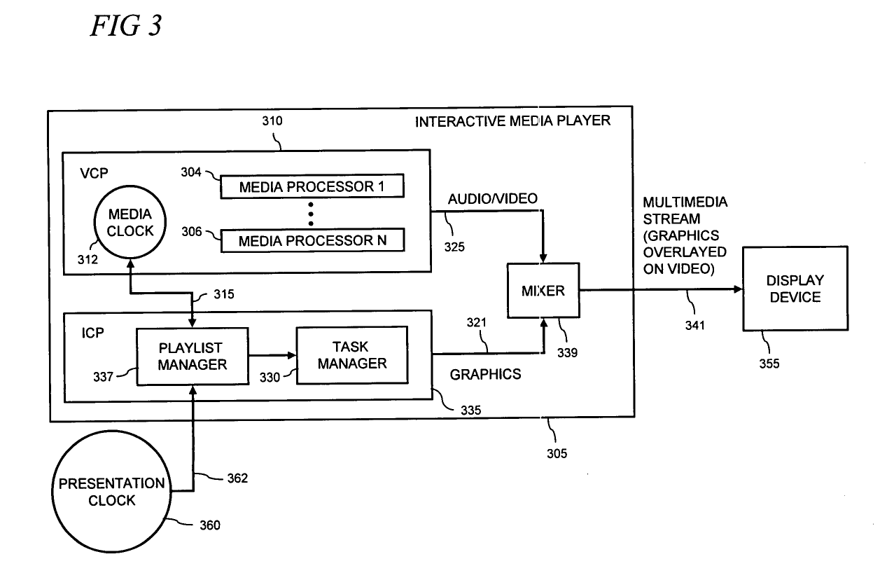

FIG. 3 is a block diagram of a first illustrative interactive media player 305 including an interactive content processor (ICP) 335, video content processor (VCP) 310, and mixer 339. It is noted that the arrangement presented in FIG. 3 provides a logical model which describe features and functions of the illustrative interactive media player 305 that are pertinent to application state management. Thus, an actual implementation of an interactive media player may utilize various structural forms while still operating as described herein to achieve the benefits of application state management. The interactive media player 305 is typically realized in dedicated hardware such as standalone consumer electronic device, or alternatively using a software implementation employing computer readable media with a general purpose processor such as that found in a personal computer.

VCP 310 manages one or more media streams that may be received from multiple sources including a local optical drives such as a DVD drive or a high-definition DVD (HD-DVD) drive, a local memory or a remote broadband source over a network. VCP 310, in this illustrative example, includes one or more media processors 1, 2 . . . N as indicated by elements 304 and 306 in FIG. 3. Media processors 304 and 306 process the received media streams, which typically include audio and video, to decode and render the corresponding images and sound which are output as an audio/video stream on line 325. Audio/video stream 325 may represent a plurality of video elements, for example to render multiple separate video windows using a “picture in picture” type configuration.

Media processors 304 and 306 each comprise a media source interface, demultiplexer and decoder. Media processors 304 and 306 may optionally include decryption capabilities as well. A display device 355 is coupled to receive and display the audio/video stream.

A media clock 312 is utilized so that each received media has an associated “Media Time.” When a video stream is paused on the interactive media player 305 then the media clock 312 is paused as well. When the video stream is set by a user to go faster or slower than real time (for example, when the video is put into fast forward, rewind or slow-motion modes—using any of these modes is referred to as “trick play”), then the media clock 312 speeds up or slows down accordingly. The Media Time is thus derived from the media clock and the operation of the media processors 304 and 306. The Media Time is passed to the playlist manager 337 in ICP 335 over line 315.

ICP 335 performs all application-related processing and may be arranged from several components that may be realized in hardware, software, firmware or a combination thereof. The components of ICP 335 include, for example, a markup processor, script language interpreter, and an XML parsing component (not shown). ICP 335 outputs a graphics stream on line 321 which is synchronous with the audio/video stream 325. Mixer 339 takes the graphics stream on line 321 and the audio/video stream on line 325 so that the graphics are rendered in a graphics layer over the video stream to implement an interactive media session for a user.

In most settings, ICP 335 outputs graphics that are synchronized on a frame-by-frame basis with the video stream. However, such synchronization may be performed using other bases, including, for example, time (including Title Time and Media time as defined below), content in the video, or other metadata embedded in the video that is used to indicate or mark a particular point in the stream.

ICP 335 includes a playlist manager 337 and a task manager 330. The playlist manager 337 is responsible for controlling presentation objects in the environment. These objects include video playback on the player 305 along with applications that are running to generate interactive graphics. Playlist manager 337 manages the playlist 290 which is described above in the text accompanying FIG. 2.

The playlist manager 337 also computes the “Title Time” associated with each portion of content in a media stream. A title is a unique sequence of video and audio content with a start and end time that is typically defined by the DVD author. However, what such author defines as a title can be arbitrary. Thus, particular content which is perceived in a video may be part of one title, a complete title, or run across multiple titles.

One example of a title is the copyright warning that precedes all pre-recorded video in both analog and digital format in the United States. The featured attraction (e.g., the main movie) on a DVD is another example and is often the longest title. In some settings, individual chapters in a movie might be designated as separates titles by the DVD author. For all such titles, Title Time is defined as the time elapsed since a given title started playing as shown on the media clock 312.

A presentation clock 360 is coupled to the playlist manager on line 362. The presentation clock 360 is a clock whose time changes at the same pace as a realworld clock (i.e., it takes one second of real time for the presentation clock 360 to advance by one second). In contrast to the media clock 312, the presentation clock 360 never stops and cannot be sped up or slowed down. The Presentation Time from the presentation clock 360 is passed to the task manager 330 which uses it to calculate “Application Time” and application “Page Time.”

Application Time is the time elapsed since an application started (or enters an “Active” state as described in more detail below). When multiple applications are in runtime, each application has a notion of its own Application Time. For each application, Application Time always starts at zero when an application is started in the environment.

For example, if an application App1 starts at Presentation Time of 20 arbitrary time units (which is 0 time units for App1) and application App2 starts at Presentation Time of 25 time units (which is 0 time units for App2), then at Presentation Time of 35 time units, Appl's Application Time is 15 time units and App2's Application Time is 10 time units. For applications that are logically subdivided into pages, the Page Time is the time elapsed since a page of an application has been loaded.

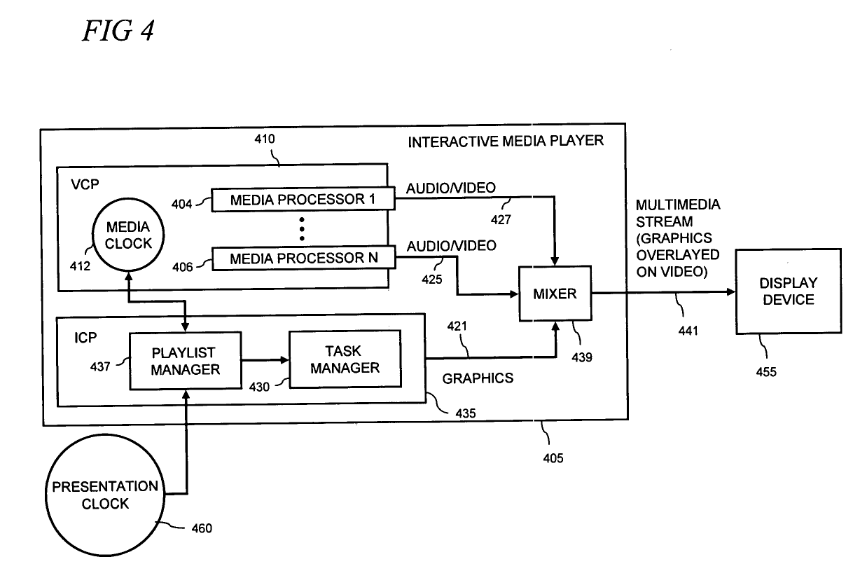

FIG. 4 is a block diagram of a second illustrative media player 405 including an ICP 435, VCP 410, and mixer 439. Interactive media player 405 is similar in form and function to the interactive media player 305 shown in FIG. 3. Notably, however, VCP 435 includes media processors, 1, 2 . . . N (as indicated by elements 404 and 406 in FIG. 4) that are arranged to provide separate feeds 425 and 427 to mixer 439. Such arrangement may be desirable in some settings where manipulation of the individual media streams is performed prior to mixing. For example, image processing/selection techniques such panning and zooming of video in a media stream may be independently implemented on one or more of the N separate feeds represented by reference numerals 425 and 427 in FIG. 4.

The audio/video feeds 425 and 427, along with the synchronous graphics stream from ICP 435 are mixed in mixer 439 and output on line 441 to a display device 455. The other elements in FIG. 4 including ICP 435 (comprising playlist manager 437 and task manager 430), media clock 412 in VCP 410 and presentation clock 460 are configured and function in a similar manner as their counterparts shown in FIG. 3 and described in the accompanying text.

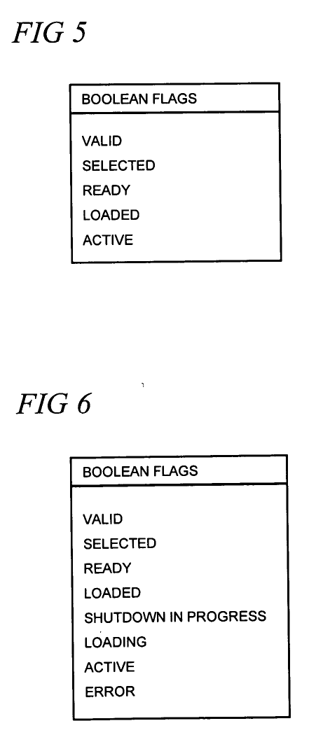

Turning now to a more detailed description of the logical model created to manage application lifetime, FIG. 5 shows a set of five elements used in first illustrative example of application state management employing Boolean flags. As shown, the set comprises the elements: Valid, Selected, Ready, Loaded and Active. In this illustrative example, an application is in a “Valid” state when the Title Time is within a predetermined timespan specified for the application in the playlist 290 (FIG. 2). Note that an application may therefore become Valid as a result of trick play. For example, another form of trick play (in addition to fast forward, rewind or slow motion) is “jumping” to a point in title by using a chapter index in a DVD. Jumping to a particular chapter in the title could make the current title time to be within a valid range for a particular application as defined in the playlist 290.

An application is in a “Selected” state when the static attributes of the application match the current dynamics attributes of interactive media player 305. Static attributes are those attributes that do not change over time. For example, an author may construct the playlist 290 (FIG. 2) to define an application to be keyed to a specific language. The interactive media player 305 (FIG. 3) may be set at application runtime to operate using a language chosen by a user. Thus, the player's current language is a dynamic attribute since it is not determined in advance. Continuing with this example then, if the author designed an application to implement a menu system in French, then should the user sets language of the player 305 to be French, the French menu application enters the Selected state. Conversely, it is possible that applications may always be Selected. For example, if the application author specifies no language (and thus the application matches any language selected for the player 305), then the application is Selected as its static attribute, language, matches a current dynamic attribute of the player 305.

Group identification (Group ID) is another example of a static attribute that may be used to match a dynamic attribute on the interactive media player 305 to thereby have an application become Selected. In this case, a group of applications may be accessed at some point during an interactive media session, for example when a game is launched. And in a similar way as with the example above, an application may always be Selected if it has no Group ID and thus not dependent on the currently selected group.

Applications that implement autorun are in the “Ready” state once the application becomes Valid (i.e., the Valid Boolean flag is “true”). For example an application may use autorun to generate a “pop up” (i.e, a small text balloon with factoids describing the underlying video) that always begins at a given point in a video program.

A second mechanism to set an application into the Ready state is to access an API to set the Ready flag. Here, another application must set the application's ready flag to true through the API if the application's autorun attribute is set to false.

An application that is set to Valid, Selected and Ready (i.e., the Valid, Selected and Ready Boolean flags are true) will begin loading resources. When loading is complete, the application will be set to “Loaded.”

An application is set to the “Active” state when it is Valid, Selected, Ready and Loaded (i.e., the Valid, Selected, Ready and Loaded Boolean flags are true). When an application is Active it is enabled to run script, handle events, access resources and the markup is processed and rendered onto the display as described above. When an application is Active its Active Boolean flag is set to true. The use of the Active Boolean flag avoids any ambiguity at application shutdown when releasing memory and the Valid, Selected and Ready flags possibly become set again.

FIG. 6 shows an extended set of eight elements used in a second illustrative example of application state management employing Boolean flags. As with the illustrative example shown in FIG. 5 and described in the accompanying text, the extended set of elements includes the elements Valid, Selected, Ready, Loaded and Active. The extended set further includes Shutdown in Progress, Loading and Error.

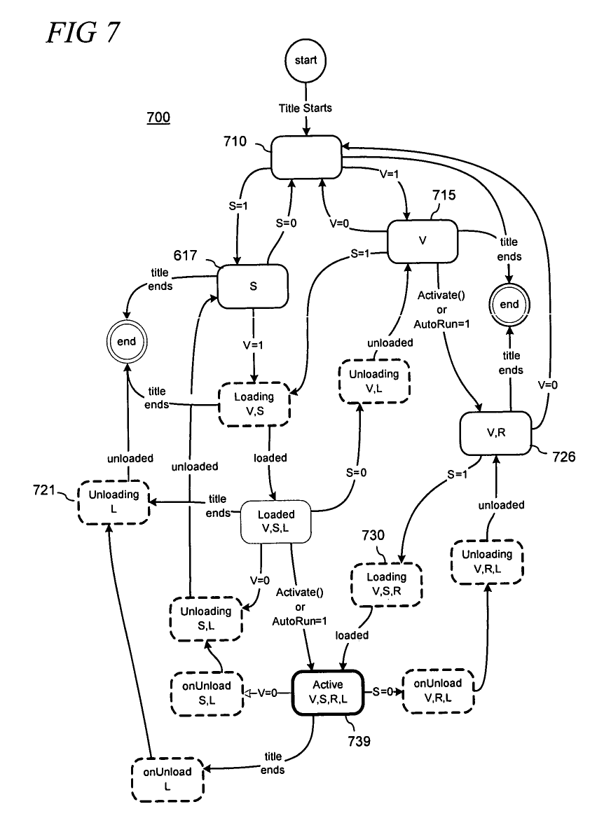

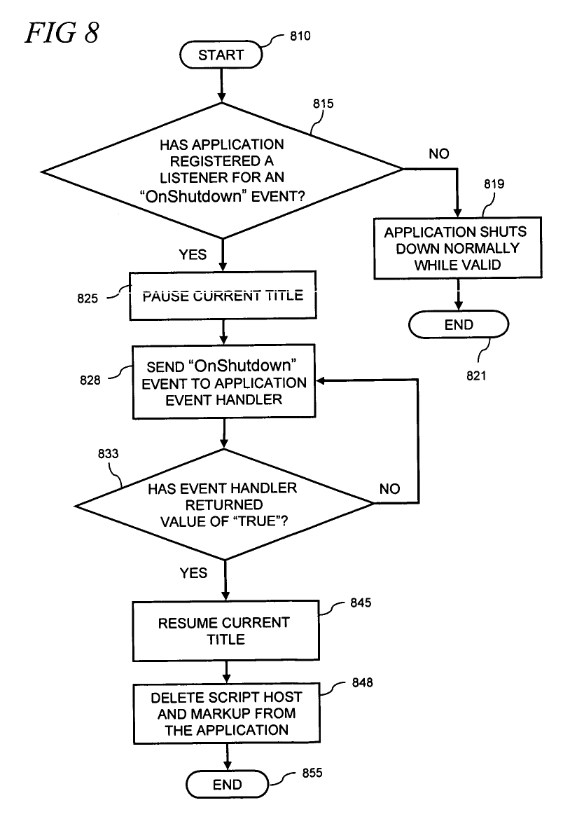

As shown in FIG. 7 and described in the accompanying text, an application is in the “Loading” state while activating and stays there only long enough to load before continuing to the Active state. The “Shutdown in Progress” state is entered when an application is engaged in the method shown below in FIG. 8 and described in the accompanying text.

An application is set to the “Error” state in the event of a fatal error (i.e., an error that causes the application to crash or freeze—usually abruptly—for which there is no ability for the application to recover by itself). The use of the Error state enables the application to be driven back to idle when a fatal error occurs.

FIGS. 5 and 6 show two sets of elements that are usable to implement application state management using Boolean flags. However, it is emphasized that these sets of elements are used to illustrate a valid logical model for managing application lifetime in an interactive media environment. Accordingly, the number and choice of elements used in specific circumstances may vary depending on the particular requirements at hand.

FIG. 7 is a diagram of a state machine 700 which illustrates transient and persistent states of an application. As shown, 23 different application states are included in the diagram. Within each box, the states (and corresponding Boolean flags) Valid, Selected, Ready and Loaded have been abbreviated to “V,” “S,” “R” and “L,” respectively. Thus, for example, when a title starts, as shown at the top of the diagram, an application at box 710 can enter either the Selected or Valid states as indicated by boxes 717 and 715, respectively. Accordingly, Boolean flags are true as indicated by S=1 and V=1 in the diagram shown in FIG. 7.

If the application is in the Valid state (and thus the Boolean flag V=1) in box 715, then the application can move to the Ready state in box 726 with R=1. As noted above, the application may become Ready by invoking an API call Active ( ) or if the application is set for AutoRun (where AutoRun=1). As indicated in the figure, to be Ready an application must be Valid.

At box 715, if an application is selected and the Boolean flag S=1, then the application becomes Loaded with L=1 since it is already Valid. As indicated by the dashed line around box 730, the “Loading” state is transient because the application moves through this state between persistent states (persistent states in FIG. 7 are indicated by solid lines). When an application is activating (i.e., enters the Active state) is goes through the Loading state long enough to actually functionally load into the player (i.e., have its markup parsed, script interpreted and required resources identified and cached) and then continues to the Active state as indicated by box 739 in FIG. 7.

FIG. 8 is a flow chart showing an illustrative method for shutting down an interactive media application. It is recognized that applications may need to perform some final processing as a part of shutting down. For example, an interactive game that is synchronized to a chapter in a movie video may need to save the user's score when the title concludes. Such needs can give rise to a variety of complicated issues. If the application leaves its valid time (i.e., is not in the Valid state) then it would need to execute program code and make multiple callbacks to script to perform the save (which implies asynchronous input/output) while not being valid. And, in order to execute script, the application would be holding onto resources while not being valid. Such a result would run counter to the notion of the playlist 290 (FIG. 2) having single responsibility for resource management.

Accordingly, applications must ordinarily reserve enough time to finish shutdown processing while still Valid. However, applications may not reserve sufficient time and a particular process for shutting down the application is followed in such instances. For example, when a trick play or jump out of an application's valid time occurs, the application must complete shutting down before the video and other applications may be started.

The process starts at block 810. At decision block 815 a determination is made as to whether the application has registered a listener for an “OnShutdown” event. If it has not, then the application is allowed to shut down normally while Valid, as shown in block 819. The process then ends at block 821.

If the application has registered an OnShutdown event listener, then the process continues at block 825 where the current title is paused. By pausing the title, Title Time is frozen which results in an application remaining Valid while it runs scripts. And, no resource conflicts can arise because no new additional applications can become Valid if the Title time is not advancing. The presentation clock (360 and 460 in FIGS. 3 and 4, respectively) continues to run which drives the application's Application Time and Page Time even though Media Time has been paused to allow the application to continue its shutdown processing.

At block 828, an OnShutdown event is sent to a handler in the application (i.e., an event listener) repeatedly until the handler returns a value of true, as shown at decision block 833. In cases where the application does not need to use an event listener, then it may be assumed that the application does not need to run script at application shutdown and the opportunity to negatively impact the video stream are minimized. Therefore, the process indicated at blocks 825 and 845 (pause and resume) may be optimized away.

Once the OnShutdown event has been handled by the application, the current title is resumed as indicated in block 845. The script host and markup are deleted from the application at block 848. Optionally, the order of these last two steps may be reversed so that the script host and markup deletion occurs prior to the resumption of the current title. The process ends at block 855.

In the particular case of applications which enable interactive games where scores need to be saved at shutdown, authors may readily handle the typical shutdown case that occurs when a movie video “normally” progresses from chapter to chapter (i.e. without the use of trick play). In this case, the application author may be expected to extend the applications time in the Valid state in the playlist 290 (FIG. 2) to allow sufficient valid time in the following movie video chapter to execute the typical shutdown process.

Optionally, the author may set up a timer to invoke a callback process executed at the end of the movie video chapter and use the callback to handle the save operation. In this case (normal progression but not trick play progression), the application may remove its event listener for the onShutdown event to thereby implement the optimizations described above.

It is noted that for the sake of clarity and ease of illustration in the description above that data, programs, and other executable program components such as operating systems are shown is discrete blocks, boxes or other elements although it is recognized and emphasized that such programs and components may reside at various times in different storage, memory or processing components of any hardware host used and are executed by one or more processors in such host hardware.

Although various illustrative arrangements and methods for managing application states in an interactive media environment have been shown and described, it should be understood that the scope of the claims appended hereto shall not necessarily be limited to the specific features, arrangements or methods described. Instead, the specific features, arrangements or methods are disclosed as illustrative forms of implementing managed applications states in an interactive media environment as more particularly claimed below.

1. A method for managing an application in an interactive media environment, the application providing one or more graphic objects that are synchronous with a video stream, the method comprising the steps of:
enabling a logical model for application lifetime in the interactive media environment wherein the logical model includes a plurality of application states;
defining each application state in the plurality of application states by a unique combination of Boolean flags; and
managing the application during runtime with other applications in the interactive media environment according to the defined applications states.

2. The method of claim 1 where the Boolean flags are selected from a plurality of Boolean flags including valid, selected, ready, loaded, shutdown in progress, loading, active and error.

3. The method of claim 2 where the valid Boolean flag is true when a title time associated with the video stream falls within a specified timespan for the application and where the application state is valid when the valid Boolean flag is true.

4. The method of claim 3 where the specified timespan is included in an application playlist, the playlist describing navigation or synchronization or initial configuration for the interactive media environment.

5. The method of claim 4 where the application playlist is encoded in a markup document such as an XML document file as defined by the World Wide Web Consortium.

6. The method of claim 1 where the step of managing includes allocating resources available in the interactive media environment to the applications depending on the application state.

7. The method of claim 2 where the selected Boolean flag is true when static attributes of the application match current dynamic attributes of a player object in the interactive media environment and where the application state is selected when the selected Boolean flag is true.

8. The method of claim 2 where the ready Boolean flag is true when the application state becomes valid and where the application state is ready when the ready Boolean flag is true.

9. The method of claim 8 where the ready Boolean flag is associated with an autorun flag for the application whereby the autorun flag is set to ready when the application state becomes valid.

10. The method of claim 1 where the application provides one or more graphic objects that are frame-synchronous with a video stream.

11. The method of claim 2 where the application is in an active state when the valid, selected and ready Boolean flags are all true.

12. The method of claim 1 where the application includes a script host having zero or more script files and zero or more markup documents as identified in a manifest file.

13. The method of claim 12 where the markup file is a single logical XML document file and may include a plurality of physical files by using an XML <include>element.

14. The method of claim 12 where the application further includes resources available to the one or more script files and the zero or one markup document.

15. An interactive media player for use in an interactive media environment, comprising:
a video content processor for processing a video object comprising streaming video having a plurality of frames;
an interactive content processor for processing a plurality of application objects, each application object providing one or more graphic objects that are synchronous with the video object, and
an application manager operating on the interactive content processor for managing the application objects according an application state, the application state being defined by a unique combination of Boolean flags that are described in an markup document.

16. The interactive media player of claim 15 where the application state further includes a persistent application state and a transient application state.

17. The interactive media player of claim 15 where synchronicity between the graphic objects and video is selected from one of time-synchronous, frame-synchronous and content-synchronous.

18. A method for shutting down an application running in an interactive media environment, the application providing one or more graphic objects that are synchronous with a video stream, the method comprising the steps of:
(a) pausing a current title running on a player in the interactive media environment to thereby hold the application in a valid state whereby a title time associated with the video object falls within a specified timespan for the application;
(b) sending a shut down event to a shut down event handler in the application;
(c) repeating step (b) until the shut down event handler returns a value of true;
(d) resuming play of the current title; and
(e) deleting any scripthost and any markup document associated with the application to thereby shut down the application.

19. The method of claim 18 further including a step of holding activation of other applications until the shut down event handler returns a value of true.

20. At least one computer-readable medium encoded with instructions which, when executed by a processor, performs the method of claim 18.
